(19) United States
(12) Patent Application Publication
(10) Pub. No.: US 2024/0373218 A1
(43) Pub. Date: Nov. 7, 2024

(54) METHOD AND APPARATUS FOR WIRELESS ACCESS TO ETHERNET NETWORK

(71) Applicant: Nokia Technologies Oy, Espoo (FI)

(72) Inventor: Alessio CASATI, WEST MOLESEY (GB)

(21) Appl. No.: 18/573,600

(22) PCT Filed: Jun. 23, 2021
(86) PCT No.: PCT/EP2021/067253

§ 371 Date: Dec. 22, 2023

(51) Int. Cl. H04W 12/06; H04W 48/10

(52) U.S. Cl. CPC H04W 12/06; H04W 48/10

(57) ABSTRACT

A technique comprising broadcasting, via a 3GPP cell, a standalone non-public-network network identifier value, and an indication of support for access to an Ethernet network via the 3GPP cell without a 3GPP network subscription identifier.

### TECHNICAL FIELD

The present disclosure relates to apparatus, a method, and a computer program, and in particular but not exclusively to apparatus, methods and computer programs for access to an Ethernet network.

### BACKGROUND

Wireless access to an Ethernet network, such as an Ethernet local area network (LAN), may, for example, be via a 3GPP cell or via a IEEE 802.11 (Wi-Fi) access point. One example of a 3GPP cell is a 5G cell, which can provide data communication over a wireless interface between a device implementing 5G user equipment functionality and an Ethernet network.

### SUMMARY

A method comprising: broadcasting, via a 3GPP cell, a standalone non-public-network network identifier value, and an indication of support for access to an Ethernet network via the 3GPP cell without a 3GPP network subscription identifier.

The indication may comprise an indication of support for open mode access or pre-shared key mode access to the Ethernet network via the 3GPP cell.

The method may further comprise receiving via the 3GPP cell from a user equipment a registration request message indicating a MAC address for the user equipment

The method may further comprise authorizing the user equipment to request a PDU session limited to said MAC address.

The method may further comprise sending a registration accept message via the 3GPP cell to the user equipment, wherein the registration accept message includes indication of support for access to said Ethernet network via an access point operating according to a IEEE 802.11 standard.

The registration accept message may indicate support for access to the Ethernet network via a IEEE 802.11 wireless access point having a service set identifier value matching the standalone-non-public-network network identifier value.

The method may further comprise broadcasting via the 3GPP cell an indication of support for access to the Ethernet network via an access point operating according to a IEEE 802.11 standard.

The method may further comprise broadcasting via the 3GPP cell an indication of support for access to the Ethernet network via a IEEE 802.11 wireless access point having a service set identifier value matching the standalone-non-public-network network identifier value.

A method comprising: detecting, from a 3GPP cell transmission, a standalone non-public-network network identifier value, and an indication of support for access to an Ethernet network via the 3GPP cell without a 3GPP network subscription identifier;
establishing an RRC connection via the 3GPP cell; transmitting a registration request message via the 3GPP cell, wherein the registration request includes a MAC address for the user equipment; receiving a registration accept message in response to the registration request message; and sending a PDU session establishment request including the MAC address.

The indication may comprise an indication of support for open mode access or pre-shared key mode access to the Ethernet network via the 3GPP cell.

The MAC address may comprise a MAC address also used for access to the Ethernet network via a IEEE 802.11 wireless access point.

Access to the Ethernet network via the 3GPP cell may use a pre-shared key also valid for access to the Ethernet network via a IEEE 802.11 access point.

A method comprising: in response to detecting, from a 3GPP cell transmission, an indication of support for access to an Ethernet network via a IEEE 802.11 wireless access point, accessing the Ethernet network via the IEEE 802.11 wireless access point having a identifier value matching a standalone-non-public-network identifier value broadcast via the 3GPP cell.

Accessing the Ethernet network via the IEEE 802.11 wireless access point may comprise a pre-shared key access mode using a pre-shared key also valid for accessing the Ethernet network via the 3GPP cell.

Apparatus, comprising: means for broadcasting, via a 3GPP cell, a standalone non-public-network network identifier value, and an indication of support for access to an Ethernet network via the 3GPP cell without a 3GPP network subscription identifier.

The indication may comprise an indication of support for open mode access or pre-shared key mode access to the Ethernet network via the 3GPP cell.

The apparatus may further comprise means for receiving via the 3GPP cell from a user equipment a registration request message indicating a MAC address for the user equipment

The apparatus may further comprise means for authorizing the user equipment to request a PDU session limited to said MAC address.

The apparatus may further comprise means for sending a registration accept message via the 3GPP cell to the user equipment, wherein the registration accept message includes indication of support for access to said Ethernet network via an access point operating according to a IEEE 802.11 standard.

The registration accept message may indicate support for access to the Ethernet network via a IEEE 802.11 wireless access point having a service set identifier value matching the standalone-non-public-network network identifier value.

The apparatus may further comprise means for broadcasting via the 3GPP cell an indication of support for access to the Ethernet network via an access point operating according to a IEEE 802.11 standard.

The apparatus may further comprise means for broadcasting via the 3GPP cell an indication of support for access to the Ethernet network via a IEEE 802.11 wireless access point having a service set identifier value matching the standalone-non-public-network network identifier value.

Apparatus comprising: means for detecting, from a 3GPP cell transmission, a standalone non-public-network network identifier value, and an indication of support for access to an Ethernet network via the 3GPP cell without a 3GPP network subscription identifier; means for establishing an RRC connection via the 3GPP cell; means for transmitting a registration request message via the 3GPP cell, wherein the registration request includes a MAC address for the user equipment; means for receiving a registration accept message in response to the registration request message; and means for sending a PD session establishment request including the MAC address.

The indication may comprise an indication of support for open mode access or pre-shared key mode access to the Ethernet network via the 3GPP cell.

The MAC address may comprise a MAC address also used for access to the Ethernet network via a IEEE 802.11 wireless access point.

Access to the Ethernet network via the 3GPP cell may use a pre-shared key also valid for access to the Ethernet network via a IEEE 802.11 access point.

Apparatus comprising means for, in response to detecting, from a 3GPP cell transmission, an indication of support for access to an Ethernet network via a IEEE 802.11 wireless access point, accessing the Ethernet network via the IEEE 802.11 wireless access point having a identifier value matching a standalone-non-public-network identifier value broadcast via the 3GPP cell.

Accessing the Ethernet network via the IEEE 802.11 wireless access point may comprise a pre-shared key access mode using a pre-shared key also valid for accessing the Ethernet network via the 3GPP cell.

An apparatus comprising: at least one processor; and at least one memory including computer program code, the at least one memory and computer program code configured to, with the at least one processor, cause the apparatus to perform: broadcasting, via a 3GPP cell, a standalone non-public-network network identifier value, and an indication of support for access to an Ethernet network via the 3GPP cell without a 3GPP network subscription identifier.

The indication may comprise an indication of support for open mode access or pre-shared key mode access to the Ethernet network via the 3GPP cell.

The at least one memory and computer program code may be configured to, with the at least one processor, cause the apparatus to: receive via the 3GPP cell from a user equipment a registration request message indicating a MAC address for the user equipment

The at least one memory and computer program code may be configured to, with the at least one processor, cause the apparatus to authorize the user equipment to request a PDU session limited to said MAC address.

The at least one memory and computer program code may be configured to, with the at least one processor, cause the apparatus to send a registration accept message via the 3GPP cell to the user equipment, wherein the registration accept message includes indication of support for access to said Ethernet network via an access point operating according to a IEEE 802.11 standard.

The registration accept message may indicate support for access to the Ethernet network via a IEEE 802.11 wireless access point having a service set identifier value matching the standalone-non-public-network network identifier value.

The at least one memory and computer program code may be configured to, with the at least one processor, cause the apparatus to broadcast via the 3GPP cell an indication of support for access to the Ethernet network via an access point operating according to a IEEE 802.11 standard.

The at least one memory and computer program code may be configured to, with the at least one processor, cause the apparatus to broadcast via the 3GPP cell an indication of support for access to the Ethernet network via a IEEE 802.11 wireless access point having a service set identifier value matching the standalone-non-public-network network identifier value.

An apparatus comprising: at least one processor; and at least one memory including computer program code, the at least one memory and computer program code configured to, with the at least one processor, cause the apparatus to perform: detecting, from a 3GPP cell transmission, a standalone non-public-network network identifier value, and an indication of support for access to an Ethernet network via the 3GPP cell without a 3GPP network subscription identifier; establishing an RRC connection via the 3GPP cell; transmitting a registration request message via the 3GPP cell, wherein the registration request includes a MAC address for the user equipment; receiving a registration accept message in response to the registration request message; and sending a PDU session establishment request including the MAC address.

The indication may comprise an indication of support for open mode access or pre-shared key mode access to the Ethernet network via the 3GPP cell.

The MAC address may comprise a MAC address also used for access to the Ethernet network via a IEEE 802.11 wireless access point.

Access to the Ethernet network via the 3GPP cell may use a pre-shared key also valid for access to the Ethernet network via a IEEE 802.11 access point.

An apparatus comprising: at least one processor; and at least one memory including computer program code, the at least one memory and computer program code configured to, with the at least one processor, cause the apparatus to perform: in response to detecting, from a 3GPP cell transmission, an indication of support for access to an Ethernet network via a IEEE 802.11 wireless access point, accessing the Ethernet network via the IEEE 802.11 wireless access point having a identifier value matching a standalone-non-public-network identifier value broadcast via the 3GPP cell.

The at least one memory and computer program code may be configured to, with the at least one processor, cause the apparatus to access the Ethernet network via the IEEE 802.11 wireless access point according to a pre-shared key access mode using a pre-shared key also valid for accessing the Ethernet network via the 3GPP cell.

Apparatus comprising broadcasting circuitry for broadcasting, via a 3GPP cell, a standalone non-public-network network identifier value, and an indication of support for access to an Ethernet network via the 3GPP cell without a 3GPP network subscription identifier.

Apparatus comprising: detecting circuitry for detecting, from a 3GPP cell transmission, a standalone non-public-network network identifier value, and an indication of support for access to an Ethernet network via the 3GPP cell without a 3GPP network subscription identifier; establishing circuitry for establishing an RRC connection via the 3GPP cell; transmitting circuitry for transmitting a registration request message via the 3GPP cell, wherein the registration request includes a MAC address for the user equipment; receiving circuitry for receiving a registration accept message in response to the registration request message; and sending circuitry for sending a PDU session establishment request including the MAC address.

Apparatus comprising accessing circuitry for, in response to detecting, from a 3GPP cell transmission, an indication of support for access to an Ethernet network via a IEEE 802.11 wireless access point, accessing the Ethernet network via the IEEE 802.11 wireless access point having a identifier value matching a standalone-non-public-network identifier value broadcast via the 3GPP cell.

A computer readable medium comprising program instructions stored thereon for performing broadcasting, via a 3GPP cell, a standalone non-public-network network identifier value, and an indication of support for access to an Ethernet network via the 3GPP cell without a 3GPP network subscription identifier.

A computer readable medium comprising program instructions stored thereon for performing: detecting, from a 3GPP cell transmission, a standalone non-public-network network identifier value, and an indication of support for access to an Ethernet network via the 3GPP cell without a 3GPP network subscription identifier; establishing an RRC connection via the 3GPP cell; transmitting a registration request message via the 3GPP cell, wherein the registration request includes a MAC address for the user equipment; receiving a registration accept message in response to the registration request message; and sending a PDU session establishment request including the MAC address.

A computer readable medium comprising program instructions stored thereon for performing, in response to detecting, from a 3GPP cell transmission, an indication of support for access to an Ethernet network via a IEEE 802.11 wireless access point, accessing the Ethernet network via the IEEE 802.11 wireless access point having a identifier value matching a standalone-non-public-network identifier value broadcast via the 3GPP cell.

A computer program comprising computer executable code which when run on at least one processor is configured to cause an apparatus at least to: broadcast, via a 3GPP cell, a standalone non-public-network network identifier value, and an indication of support for access to an Ethernet network via the 3GPP cell without a 3GPP network subscription identifier.

A computer program comprising computer executable code which when run on at least one processor is configured to cause an apparatus at least to: detect, from a 3GPP cell transmission, a standalone non-public-network network identifier value, and an indication of support for access to an Ethernet network via the 3GPP cell without a 3GPP network subscription identifier; establish an RRC connection via the 3GPP cell; transmit a registration request message via the 3GPP cell, wherein the registration request includes a MAC address for the user equipment; receive a registration accept message in response to the registration request message; and send a PDU session establishment request including the MAC address.

A computer program comprising computer executable code which when run on at least one processor is configured to cause an apparatus at least to: in response to detecting, from a 3GPP cell transmission, an indication of support for access to an Ethernet network via a IEEE 802.11 wireless access point, access the Ethernet network via the IEEE 802.11 wireless access point having a identifier value matching a standalone-non-public-network identifier value broadcast via the 3GPP cell.

A non-transitory computer readable medium comprising program instructions stored thereon for performing broadcasting, via a 3GPP cell, a standalone non-public-network network identifier value, and an indication of support for access to an Ethernet network via the 3GPP cell without a 3GPP network subscription identifier.

A non-transitory computer readable medium comprising program instructions stored thereon for performing: detecting, from a 3GPP cell transmission, a standalone non-public-network network identifier value, and an indication of support for access to an Ethernet network via the 3GPP cell without a 3GPP network subscription identifier; establishing an RRC connection via the 3GPP cell; transmitting a registration request message via the 3GPP cell, wherein the registration request includes a MAC address for the user equipment; receiving a registration accept message in response to the registration request message; and sending a PDU session establishment request including the MAC address.

A non-transitory computer readable medium comprising program instructions stored thereon for performing in response to detecting, from a 3GPP cell transmission, an indication of support for access to an Ethernet network via a IEEE 802.11 wireless access point, accessing the Ethernet network via the IEEE 802.11 wireless access point having a identifier value matching a standalone-non-public-network identifier value broadcast via the 3GPP cell.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows a representation of an example system according to some example embodiments;

FIG. 2 shows a representation of an example of operations at devices implementing 5G functions according to example embodiments.

FIG. 3 shows a representation of another example of operations at devices implementing 5G functions according to example embodiments.

FIG. 4 shows a representation of another example of operations at a device implementing both 5G UE functionality and Wi-Fi functionality;

FIG. 5 shows a representation of another example of operations at a device implementing both 5G UE functionality and Wi-Fi functionality;

FIG. 6 shows a representation of an example of non-volatile memory media; and

FIG. 7 illustrates an example system to which embodiments may be applied.

### DETAILED DESCRIPTION

The following detailed description of some example embodiments makes mention of a 5G cell broadcasting a standalone non-public-network (SNPN) network identifier and devices implementing 5G user equipment (UE) functionality, but the underlying technique is also applicable to e.g. other 3GPP cells including more evolved 3GPP cells, and e.g. devices implementing UE functionality in other 3GPP systems including more evolved 3GPP systems.

In the following description, a SNPN may refer to a non-public-network (otherwise called a private network) that does not rely on network functions provided by a Public Land Mobile Network (PLMN) owned by a mobile network operator.

A 3GPP cell may or may not be part of a co-ordinated group of 3GPP cells operated by one or more 3GPP base stations.

Devices implementing UE functionality may include mobile or static devices (e.g. a portable or non-portable computing device), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

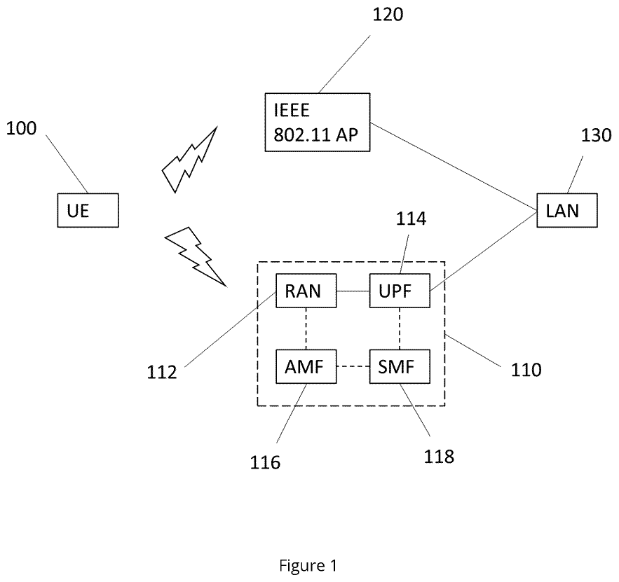

FIG. 1 shows a representation of some elements and functional entities of an example system according to some example embodiments. The connections shown in FIG. 1 are logical connections; the actual physical connections may be different. It is apparent to a person skilled in the art that the system may comprises also other functions and structures than those shown in FIG. 1.

The embodiments are not restricted to the system given as an example but a person skilled in the art may apply the solution to other communication systems provided with necessary properties.

The one or more devices/components 110 implementing 5G network functionality include one or more devices/components 112 implementing 5G RAN functionality. The one or more devices/components implementing 5G RAN functionality may include one or more gNodeBs (gNB) s, which gNBs may, for example, be referred to as base stations. The one or more gNBs may include radio transceivers and antenna units via which bi-directional radio links can be established to UE 100. The antenna unit comprises a plurality of antennas or antenna elements. The one or more devices/components 112 implementing 5G RAN functionality are connected to one or more devices/components implementing 5G core network (5GC) functionality. The devices/components implementing 5G core network (5GC) functionality devices include: one or more devices/components implementing 5GC control plane functions (including the Access and Mobility Management Function 116 (AMF) and Session Management Function (SMF) 118 mentioned below), and one or more devices/components 114 implementing user plane functions (including the 5G User Plane Function (UPF) mentioned below).

In one example, the devices/components implementing the above-mentioned 5GC functions are co-located, and the device/components implementing the 5G RAN functionality may also be co-located with the devices/components implementing the 5GC functions.

According to example embodiments, one function of the UPF is to transfer Ethernet protocol data units in one or both directions between the one or more devices/components implementing 5G RAN functionality and an Ethernet local area network (LAN) 130.

In this example, the system also includes one or more access points (AP) 120 (only one shown in FIG. 1) operating according to an IEEE 802.11 standard (hereafter also referred to as a Wi-Fi), and providing alternative wireless access to the Ethernet local area network (LAN) 130. The 5G RAN may have a wider range of coverage than the combined coverage area of the one or more Wi-Fi access points. In some embodiments there may also be no Wi-Fi access points and the Ethernet LAN may be accessible only via 5G RAN nodes.

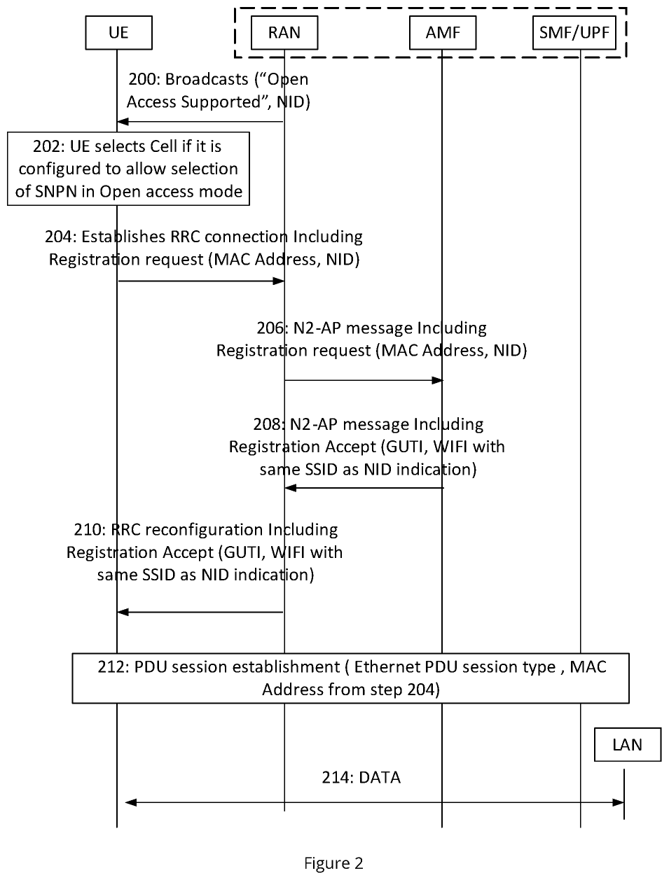

FIG. 2 shows a representation of an example of operations at a UE device 100 implementing 5G UE functionality, and at devices of a 5G SNPN, including a RAN device 112 implementing 5G RAN functionality, a AMF device 116 implementing 5G AMF functionality, and a SMF/UPF 118/114 device implementing 5G SMF and UPF functionality.

The master information block (MIB) broadcast via a 5G cell broadcast channel by RAN device 112 includes an indication that the 5G SNPN supports an open mode of access to Ethernet LAN 130, and includes a network identifier (NID) (OPERATION 200). When UE device 100 moves into the range of coverage of the 5G SNPN (or when it is switched on in a location within the range of coverage of 5G SNPN), UE device 100 detects the MIB and the indication of a possibility of open mode of access.

In accordance with the configuration of UE device 100, UE device 100 determines to select open mode of access to Ethernet LAN 130 via the 5G SNPN cell (OPERATION 202).

UE device 100 establishes an RRC connection with the 5G RAN device 112. The procedure of establishing an RRC connection with the RAN device 112 includes the UE device 100 transmitting to the RAN device 112 a RRC message carrying a registration request message (OPERATION 204). The registration request message includes a MAC address for the UE device 100, and the NID indicated in the MIB for open mode access to Ethernet LAN via the 5G SNPN. The registration request message does not include any subscription identifier such as SUCI (Subscription Concealed Identifier) or SUPI (Subscription Permanent Identifier). According to one example, UE device 100 may also be equipped with a Wi-Fi radio adapter (in addition to a 5G NR adapter for 5G UE functionality), and the MAC address included in the registration request message may be the MAC address of the Wi-Fi adapter of UE device 100. According to another example, the MAC address included in the registration request message may be an “privacy mode” autogenerated MAC address. The autogenerated MAC address may be the same as that used by UE device 100 for Wi-Fi communications.

RAN device 112 sends to AMF device 116 an N2-AP message carrying the registration request message received from UE device 100 (OPERATION 206).

The AMF device 114 sends to the RAN device 112 a N2-AP message carrying a registration accept message addressed to the UE device 100 (OPERATION 208). The registration accept message includes a GUTI (Globally Unique Temporary Identifier) for UE device 100.

In this example, the registration accept message also includes an indication (hereafter referred to as “Wi-Fi indication”) that wireless access to the Ethernet LAN 130 is also possible via a IEEE 802.11 wireless access point (AP). According to one example, this Wi-Fi indication may include the SSID (Service Set Identifier) value for the IEEE 802.11 AP. As mentioned further below: according to another example, the SSID value for the IEEE802.11 AP is assigned the same value as the above described NID value for the 5G SNPN; and the Wi-Fi indication without SSID value triggers the connection manager function of UE device 100 to look for a IEEE 802.11 AP having an SSID value matching the NID value for the 5G SNPN.

AMF device 114 may or may not have first communicated with SMF device 116 about authorisation of sessions for the MAC address included in the registration request message from UE device 100.

The RAN device 112 transmits to UE device 100 a RRC reconfiguration message carrying the registration accept message received from AMF device 114 (OPERATION 210).

A PDU session is established between the UE device 100 and the UPF device 112 (OPERATION 212). The PDU session is an Ethernet PDU session type, and is identified by the MAC address included in the registration request sent from UE device 100 to RAN device 112 in OPERATION 204.

The established PDU session is used to transfer data between UE device 100 and Ethernet LAN 130 (OPERATION 214).

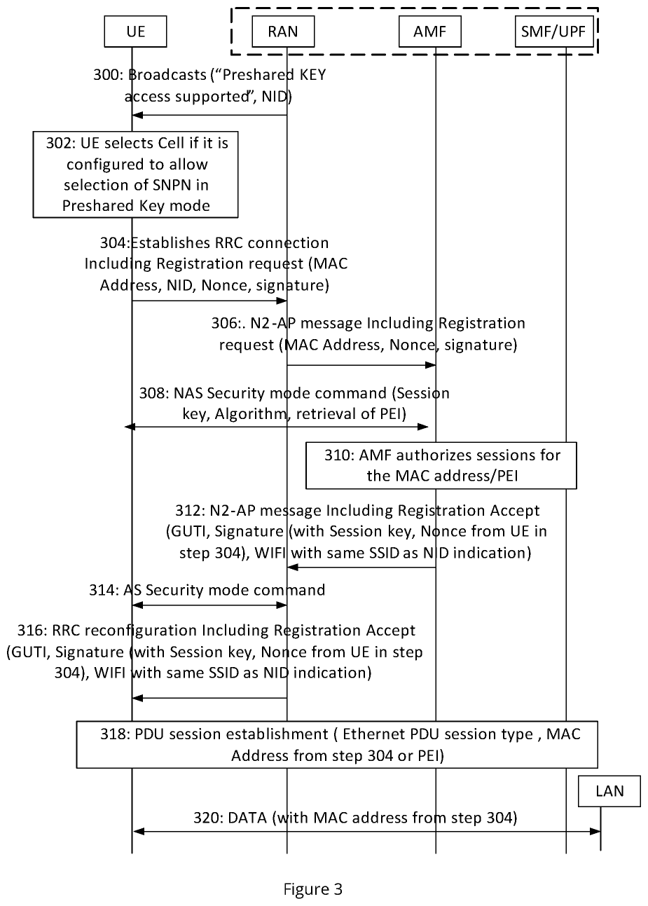

FIG. 3 shows a representation of another example of operations at a UE device 100 implementing 5G UE functionality, and at devices of a 5G SNPN, including a RAN device 112 implementing 5G RAN functionality, a AMF device 116 implementing 5G AMF functionality, and a SMF/UPF 118/114 device implementing 5G SMF and UPF functionality.

The master information block (MIB) broadcast via a 5G cell broadcast channel by RAN device 112 includes an indication that the 5G SNPN supports a pre-shared key mode of access to Ethernet LAN 130, and includes a network identifier (NID) (OPERATION 300). When UE device 100 moves into the range of coverage of the 5G SNPN (or when it is switched on in a location within the range of coverage of 5G SNPN), UE device 100 detects the MIB and the indication of a possibility of pre-shared key mode of access to Ethernet LAN 130 via the 5G SNPN.

In accordance with the pre-configuration of UE device 100, UE device 100 determines to select pre-shared key mode of access to Ethernet LAN 130 via the 5G SNPN (OPERATION 302).

UE device 100 establishes an RRC connection with the 5G RAN device 112. The procedure of establishing an RRC connection with the RAN device 112 includes the UE device 100 transmitting to the RAN device 112 a RRC message carrying a registration request message (OPERATION 304). The registration request message includes: a MAC address for UE device 100; the NID indicated in the MIB for pre-shared key mode access to Ethernet LAN 130 via the 5G SNPN; a nonce value; and a signature value.

The registration request message does not include any subscription identifier such as SUCI or SUPI. According to one example, UE device 100 may also be equipped with a Wi-Fi radio adapter (in addition to a 5G NR adapter for 5G UE functionality), and the MAC address included in the registration request message may be the MAC address of the Wi-Fi adapter of UE device 100. According to another example, the MAC address included in the registration request message may be a “privacy mode” autogenerated MAC address. The autogenerated MAC address may be same as that used by UE device 100 for Wi-Fi communications.

RAN device 112 sends to AMF device 116 an N2-AP message carrying the registration request message received from UE device 100 (OPERATION 306).

Next follows NAS (non-access-stratum) security messages between UE device 100 and AMF device 114 via RAN device 112 (OPERATION 310). AMF device 114 sends a NAS security command to UE device 100 to retrieve a permanent equipment identifier (PEI) for UE device 100. The NAS security command indicates the pre-shared KEY algorithm selected for key derivation and encryption, and indicates a session KEY (or more session KEYs) to be used for NAS interaction and KEY derivation.

AMF device 114 communicates with SMF device 116 about the authorisation of data using the MAC address, and the authorisation of PDU sessions requested using the MAC address or the PEI received from UE device 100 (OPERATION 312).

AMF device 114 sends to the RAN device 112 a N2-AP message carrying a registration accept message addressed to UE device 100 (OPERATION 314). The registration accept message includes: a GUTI (Globally Unique Temporary Identifier) to identify the UE device during the session(s) and a signature value generated using the above-mentioned session key and above-mentioned nonce value received from UE device 100.

In this example, the registration accept message also includes an indication (hereafter referred to as “Wi-Fi indication”) that wireless access to the Ethernet LAN 130 is also possible via a IEEE 802.11 wireless AP. According to one example, this Wi-Fi indication may include the SSID value for the IEEE802.11 AP. As mentioned further below: according to another example, the SSID value for the IEEE802.11 AP is assigned the same value as the above described NID value for the 5G SNPN; and the Wi-Fi indication without SSID value triggers UE device 100 to look for a IEEE 802.11 AP having an SSID value matching the NID value for the 5G SNPN.

The RAN device 112 transmits to UE device 100 a RRC reconfiguration message carrying the registration accept message received from AMF device 114 (OPERATION 316).

A PDU session is established between the UE device 100 and the UPF device 112 (OPERATION 318). The PDU session is an Ethernet PDU session type, and is identified by the MAC address included in the registration request sent from UE device 100 to RAN device 112 in OPERATION 304, and/or by the PEI included by UE device 100 in the reply to the NAS security command.

The established sessions are used to transfer data between UE device 100 and Ethernet LAN 130 (OPERATION 320).

Another example of performing mutual authentication between the 5G SNPN and UE device 100 may comprise the following. The AMF device 116 includes in the registration accept message a nonce value encrypted and signed with the shared secret; and the UE device 100 and the AMF device 116 may use a chain of the UE Nonce value (nonce value included by UE device in the registration request message) and the network Nonce value (nonce value included in the registration accept message) to generate signatures for integrity protection of the Non Access Stratum (NAS) messages. The UE device 100 and AMF device 116 may, at any time, replace an existing nonce value with a new nonce value.

Regarding the derivation of session key(s) from the pre-shared key, one example involves deriving at least one key for control plane session(s) and at least one key for user plane session(s). Once a session key is derived, the session key is used between UE device 100 and AMF device 116 for NAS signalling messages until a new session key is generated (by derivation from the pre-shared key). The 5G SNPN core network may provide an initial master session key from which both the control plane session key and the user plane session key are generated.

As mentioned above, the 5G SNPN may indicate to UE device 100 that wireless access to the Ethernet LAN 130 is also possible via a IEEE 802.11 wireless AP. This indication may, for example, be included in a registration accept message sent from RAN device 112 to UE device 100 (as mentioned above), or may be included in the master information block (MIB) broadcast by RAN device 112.

According to one example embodiment, the same value is assigned to both (a) the SSID for the IEEE 802.11 AP via which the Ethernet LAN 130 is accessible; and (b) the NID for the 5G SNPN via which the Ethernet LAN 130 is accessible. Additionally, if access to the Ethernet LAN 130 via the 5G SNPN is pre-shared key access, the same value may be assigned to both the pre-shared key for 5G SNPN access and the security key (e.g. WPA (Wi-Fi protected access) key) for IEEE 802.11 access.

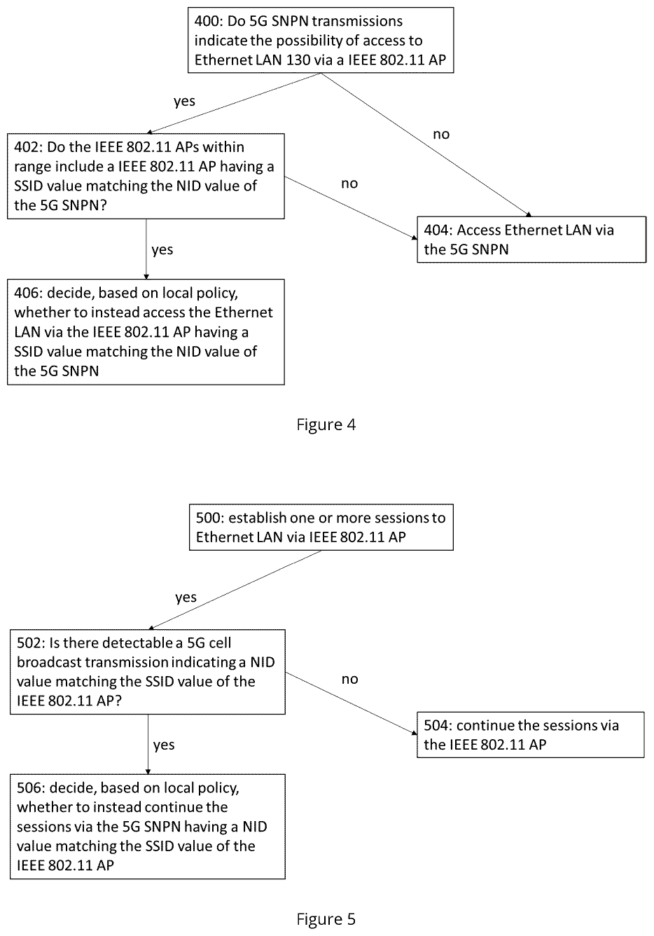

FIG. 4 shows a representation of an example of operations at a device having both Wi-Fi functionality and 5G UE functionality (such as UE device 100 in FIG. 1). UE device 100 looks (either in e.g. the registration accept message mentioned above, or a MIB broadcast via the 5G SNPN cell) for a 5G SNPN indication that the Ethernet LAN 130 is also accessible via a IEEE 802.11 AP (OPERATION 400). In response to detecting such an indication, UE device 100 may search for a IEEE 802.11 wireless AP having a SSID value matching the NID value for the 5G SNPN (OPERATION 402). If a IEEE 802.11 AP having an SSID value matching the NID value of the 5G SNPN is within range, UE device 100 may decide, based on a policy configured in the UE device 100, to instead access the Ethernet LAN 130 via the IEEE 802.11 wireless AP having a SSID value matching the NID value for the 5G SNPN (even if access via the 5G cell of the SNPN is available) (OPERATION 404). If no IEEE 802.11 AP having a SSID value matching the 5G SNPN NID value is within range of UE device 100, UE device 100 accesses (or continues to access) the Ethernet LAN 130 via 5G SNPN (OPERATION 406). As mentioned above, if access to the Ethernet LAN 130 via the 5G SNPN adopts a pre-shared key access mode, switching between 5G SNPN access and IEEE 802.11 access is further facilitated by using the same value for the pre-shared key for 5G SNPN access and a security key (e.g. WPA (Wi-Fi protected access) key) for IEEE 802.11 access.

FIG. 5 shows a representation of operations at UE device 100 according to another example embodiment While one or more sessions are existing between UE device 100 and Ethernet LAN 130 via a IEEE 802.11 AP (OPERATION 500 of FIG. 5), UE device 100 looks out for a 5G cell broadcast transmission (e.g. MIB transmission) indicating a NID value matching the SSID value for the IEEE 802.11 AP via which UE device 100 has established one or more sessions to Ethernet LAN 130 (OPERATION 502). If UE device 100 detects a 5G cell broadcast transmission including a NID value matching the SSID value for the IEEE 802.11 AP, UE device 100 may then, based on a policy configured in the UE device 100, automatically select 5G SNPN access (open access mode or pre-shared key access mode) to continue the existing sessions between UE device 100 and Ethernet LAN 130 (OPERATION 504). If no 5G cell transmission including a NID value matching the SSID value of the IEEE 802.11 AP is detected, UE device 100 continues the sessions via the IEEE 802.11 AP (OPERATION 506).

In the above-described example embodiments, co-ordination between 5G SNPN access and IEEE 802.11 (Wi-Fi) access is achieved by e.g. including the above-mentioned Wi-FI indication in a 5G cell transmission (e.g. 5G cell MIB or registration accept message), and using the same value for the IEEE 802.11 AP SSID and the 5G SNPN NID. In the absence of any such Wi-Fi indication, the two access types (5G SNPN access and IEEE 802.11 access) operate independently.

The above-described embodiments better enable compatibility of a 5G network with an Ethernet network used in a residential, hotspot and small office environment. The above-described embodiments provide a systematic way to enable a user to access an Ethernet LAN via a 5G network in the same way as accessing the Ethernet LAN via a IEEE 802.11 network. The above-described example embodiments better facilitate accessing an Ethernet network via a 5G network, with the same kind of ease as accessing the Ethernet LAN via a IEEE 802.11 network.

In the above-described example embodiments, open mode and shared key mode is supported for both access via a 5G network an access via a IEEE 802.11 network. Access via the 5G network either involves zero encryption (open mode), or encryption without association to a subscriber identifier such as SUPI (shared key mode).

In the above-described example embodiment, the same network identifier value is used for both the IEEE 802.11 wireless AP and the 5G SNPN deployed at the same venue for access to the same private Ethernet network. The SSID for the IEEE 802.11 AP has the same value as the NID for the 5G SNPN. In the above-described example embodiments, the same key is used for both 5G pre-shared key access and IEEE 802.11 access. The above-described example embodiments better enable integration and coexistence of both IEEE 802.11 and 3GPP access technologies in a seamless way. In the example embodiments described above, open mode access or shared key mode access is automatically triggered by selecting the 5G network for access to the Ethernet LAN.

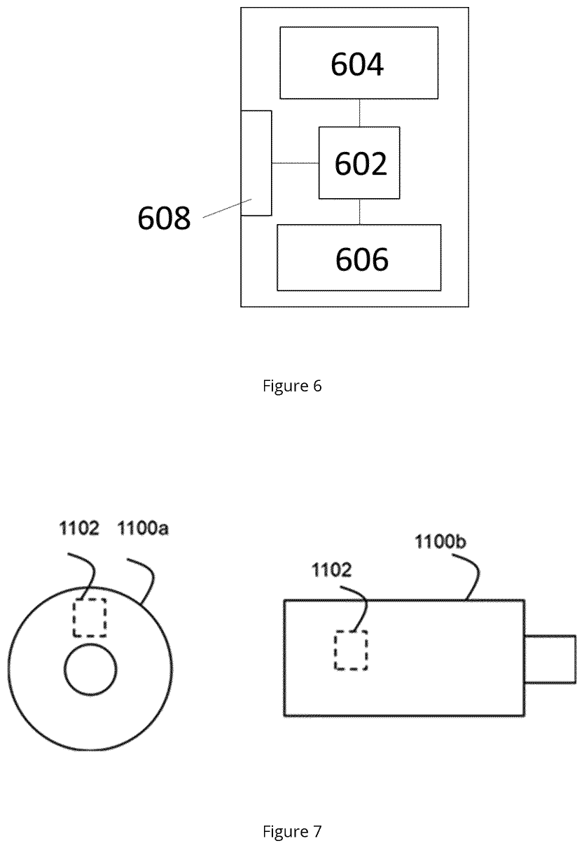

FIG. 6 illustrates an example of an apparatus for implementing the operations of a device implementing 5G UE functionality or a device implementing 5G gNB functionality in the embodiments described above. The apparatus may comprise at least one processor 602 coupled to one or more interfaces 608 to e.g. other equipment. In the case of a device implementing UE functionality, the one or more interfaces may be to other devices for which the UE functionality provides radio communications. In the case of a device implementing 5G gNB functionality, the one or more interfaces include interfaces to other 5G network components such as the component implementing the 5GC functions shown in FIG. 1. At least one processor 602 is also coupled to a radio unit 604 including one or more antennas etc. for making and receiving radio transmissions. The at least one processor 602 may also be coupled to at least one memory 606. The at least one processor 602 may be configured to execute an appropriate software code to perform the operations described above. The software code may be stored in the memory 606

FIG. 7 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods described previously.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-54. (canceled)

55. An apparatus comprising:
at least one processor; and
at least one memory including computer program code, the at least one memory and computer program code configured to, with the at least one processor, cause the apparatus at least to:
broadcast, via a 3GPP cell, a standalone non-public-network network identifier value, and an indication of support for access to an Ethernet network via the 3GPP cell without a 3GPP network subscription identifier.

56. The apparatus according to claim 55, wherein the at least one memory and computer program code are configured to, with the at least one processor, further cause the apparatus at least to:
receive, via the 3GPP cell, a registration request message from a user equipment, the registration request message indicating a MAC address for the user equipment.

57. The apparatus according to claim 55,
wherein the indication comprises an indication of support for open mode access or pre-shared key mode access to the Ethernet network via the 3GPP cell.

58. The apparatus according to claim 57, wherein the at least one memory and computer program code are configured to, with the at least one processor, further cause the apparatus at least to:
receive, via the 3GPP cell, a registration request message from a user equipment, the registration request message indicating a MAC address for the user equipment.

59. The apparatus according to claim 58, wherein the at least one memory and computer program code are configured to, with the at least one processor, further cause the apparatus to:
send, via the 3GPP cell, a registration accept message to the user equipment,
wherein the registration accept message includes indication of support for access to said Ethernet network via an access point operating according to an IEEE 802.11 standard.

60. The apparatus according to claim 58, wherein the at least one memory and computer program code are configured to, with the at least one processor, further cause the apparatus at least to:
authorize the user equipment to request a PDU session limited to said MAC address.

61. The apparatus according to claim 60, wherein the at least one memory and computer program code are configured to, with the at least one processor, further cause the apparatus to:
send, via the 3GPP cell, a registration accept message to the user equipment,
wherein the registration accept message includes indication of support for access to said Ethernet network via an access point operating according to an IEEE 802.11 standard.

62. The apparatus according to claim 61,
wherein the registration accept message indicates support for access to the Ethernet network via an IEEE 802.11 wireless access point having a service set identifier value matching the standalone-non-public-network network identifier value.

63. The apparatus according to claim 55, wherein the at least one memory and computer program code are configured to, with the at least one processor, further cause the apparatus to:
broadcast, via the 3GPP cell, an indication of support for access to the Ethernet network via an access point operating according to an IEEE 802.11 standard.

64. The apparatus according to claim 63, wherein the at least one memory and computer program code are configured to, with the at least one processor, further cause the apparatus to:
broadcast, via the 3GPP cell, an indication of support for access to the Ethernet network via an IEEE 802.11 wireless access point having a service set identifier value matching the standalone-non-public-network network identifier value.

65. The apparatus according to claim 57, wherein the at least one memory and computer program code are configured to, with the at least one processor, further cause the apparatus to:
broadcast, via the 3GPP cell, an indication of support for access to the Ethernet network via an access point operating according to an IEEE 802.11 standard.

66. The apparatus according to claim 65, wherein the at least one memory and computer program code are configured to, with the at least one processor, further cause the apparatus to:
broadcast, via the 3GPP cell, an indication of support for access to the Ethernet network via an IEEE 802.11 wireless access point having a service set identifier value matching the standalone-non-public-network network identifier value.

67. An apparatus comprising:
at least one processor; and
at least one memory including computer program code, the at least one memory and computer program code configured to, with the at least one processor, cause the apparatus at least to:
detect, from a 3GPP cell transmission, a standalone non-public-network network identifier value, and an indication of support for access to an Ethernet network via the 3GPP cell without a 3GPP network subscription identifier;
establish an RRC connection via the 3GPP cell;
transmit a registration request message via the 3GPP cell, wherein the registration request includes a MAC address for the user equipment;
receive a registration accept message in response to the registration request message; and
send a PDU session establishment request including the MAC address.

68. The apparatus according to claim 67,
wherein the indication comprises an indication of support for open mode access or pre-shared key mode access to the Ethernet network via the 3GPP cell.

69. The apparatus according to claim 68,
wherein the MAC address comprises a MAC address also used for access to the Ethernet network via an IEEE 802.11 wireless access point.

70. The apparatus according to claim 68,
wherein access to the Ethernet network via the 3GPP cell uses a pre-shared key also valid for access to the Ethernet network via an IEEE 802.11 access point.

71. An apparatus comprising:
at least one processor; and
at least one memory including computer program code, the at least one memory and computer program code configured to, with the at least one processor, cause the apparatus at least to:
in response to detecting, from a 3GPP cell transmission, an indication of support for access to an Ethernet network via an IEEE 802.11 wireless access point, access the Ethernet network via the IEEE 802.11 wireless access point having an identifier value matching a standalone-non-public-network identifier value broadcast via the 3GPP cell.

72. The apparatus according to claim 71, wherein the at least one memory and computer program code are configured to, with the at least one processor, further cause the apparatus at least to:
access the Ethernet network via the IEEE 802.11 wireless access point according to a pre-shared key access mode using a pre-shared key also valid for accessing the Ethernet network via the 3GPP cell.
